(19) United States
(12) Patent Application Publication
(10) Pub. No.: US 2008/0274309 A1
(43) Pub. Date: Nov. 6, 2008

(54) INK JET RECORDING MEDIA HAVING ENHANCED TOUGHNESS

(75) Inventors: Chuan Lee, Greer, SC (US); Ekaterini Bogas Beauvais, Fountain Inn, SC (US); Stephen James Rudy, Greenwood, SC (US)

Correspondence Address: THOMPSON HINE L.L.P.;Intellectual Property Group, P.O. BOX 8801, DAYTON, OH, 45401-8801, US

(73) Assignee: FUJIFILM MANUFACTURING U.S.A. INC., Greenwood, SC (US)

(21) Appl. No.: 11/744,023

(22) Filed: May 3, 2007

(51) Int. Cl. B41M 5/40; B41M 5/00

(52) U.S. Cl. 428/32.24; 428/32.38

(57) ABSTRACT

A ink jet recording medium and, in particular, an ink jet recording medium of photographic quality that in one embodiment exhibits scratch resistance and/or toughness and/or resistance to softening upon printing.

### TECHNICAL FIELD

The present invention relates generally to an ink jet recording medium and, in particular, to an ink jet recording medium of photographic quality that is useful with aqueous printing inks.

### BACKGROUND OF THE INVENTION

In a typical ink jet recording system, ink droplets are ejected from a nozzle at high speeds towards a recording element or medium to produce an image. The ink droplets generally comprise a dye and a relatively large amount of solvent. The solvent typically is made up largely of water and organic additives such as alcohols and the like. The ink jet recording medium is designed to readily absorb the ink droplets while preventing droplet diffusion or migration. In this manner, good image sharpness and color intensity can be obtained.

One approach to providing photographic quality ink jet images is to provide a substrate with a porous recording layer, which can act as the ink receiving layer. However, recording media employing porous recording layers often do not have the desired gloss or fade resistance (e.g., atmospheric elements such as ozone can penetrate the microporous structure and degrade aqueous inks). In some cases, a microporous ink-receiving layer may be provided on top of the porous layer to compensate for the low gloss. This microporous layer functions to absorb the ink solvent. Some typical examples of microporous recording media are described in U.S. Pat. Nos. 4,833,172; 4,861,644 and 5,326,391.

Another approach for producing photographic quality ink jet recording media involves the use of water swellable ink-receptive layers. In this type of recording media, at least one ink-receptive layer is coated on a support such as paper or a transparent film. The ink-receptive layer(s) typically contains one or more water swellable binders or hydrophilic polymers and, in some cases, fillers. Proportions of these components affect the properties of the coating, in particular, ink-absorption properties and the gloss quality appearance of the ink jet media. The liquid absorptivity of these layers is important.

Another approach for producing ink jet recording media with photographic quality and good drying properties is the so called non-micro porous film type as proposed in patent publications such as EP-A-806 299 and JP-A-22 76 670. For this type of ink jet recording medium, at least one ink receptive layer is coated on a support such as a paper or a transparent film. The ink receptive layer typically contains various proportions of water swellable binders and fillers. The proportions of these components affect the properties of the coatings, in particular ink absorption properties and the gloss quality appearance of the ink jet media.

U.S. Pat. No. 4,379,804 discloses recording media in which gelatin is used in ink-receiving layers of ink jet recording sheets. The gelatin is said to improve smudge resistance, increase the definition quality give high gloss, fast water absorbing properties, easy to achieve high water resistance, and good dye fading resistance.

U.S. Pat. No. 5,723,211 describes an ink jet recording element comprising a substrate, a solvent absorbing gelatin layer and an ink-receiving layer. Good drying, high optical densities good water fastness and excellent off set and smut resistance is claimed.

International (PCT) Application WO-A-00/37260 describes an image-recording element with a top layer and an ink receiving layer, in which the ink-receiving layer mainly comprises gelatin with a pH at much higher or lower level than the gelatin's isoelectric point (IEP) to improve drying. Through the use of the top layer, physical protection for the underlying layer, reduced tackiness and a glossy appearance is obtained.

European Patent EP-A-0 830 952 describes an ink jet recording sheet in which the ink-receiving layer contains gelatin with an IEP of 5.5 to 9.6 together with a cationic and optionally a hydrophilic polymer. According to the disclosure in this patent, water resistance and gloss is improved.

One of the difficulties that is encountered in designing and developing ink jet recording media that incorporate water swellable ink-receptive layers is that these layers can become soft and lose substantial integrity when they are wetted by the ink. Ink jet media using polyvinyl alcohol coatings give very good absorptivity of aqueous inks. This leads to very good image quality on most printers. However, when wetted with the ink the polyvinyl alcohol provides weak adhesion or cohesion between coated materials. When the recording layer(s) absorbs the ink, particularly in areas of high image density, the recording layer(s) can become soft. This can result in weak scratch resistance and/or loss of printed gloss of the freshly printed media. This can also result in image damage as the printed sheet is conveyed over and between the rollers in the printer. If the ink-receptive layer becomes soft as a result of ink absorption, the paper conveying rollers and devices in the printer may scratch, cause printing wheel tracks, or compress or otherwise damage the printed image.

### SUMMARY OF THE INVENTION

Certain embodiments of the present invention provide a ink jet recording media and, more particularly, a ink jet recording medium of water-swellable type, which exhibits one or more of the following effects: improved toughness and/or scratch resistance, high absorptivity, high printed gloss, excellent image quality.

In accordance with one embodiment of the invention, an ink-receptive layer is provided comprising a hydrophilic polymer and a polystyrene-acrylic resin.

In another embodiment of the invention, an ink-receptive layer is provided comprising a hydrophilic polymer and a polycarbonate-urethane layer.

In still another embodiment of the invention, an ink jet recording medium is provided, which comprises both a layer of a hydrophilic polymer and a polystyrene-acrylic resin and a layer of a hydrophilic polymer and a polycarbonate-urethane resin.

### DETAILED DESCRIPTION OF THE INVENTION

In accordance with various embodiments of the invention, the ink jet recording medium is made up of a plurality of layers that are contiguously coated on a substrate. These layers may contain gelatin and/or polyvinyl alcohol (PVA). The layers are arranged on the substrate in order to obtain the desired gloss, toughness, humidity fastness and water resistance.

In accordance with one embodiment of the invention, a polycarbonate-urethane resin is added to a recording layer containing polyvinyl alcohol.

In accordance with another embodiment of the invention, a styrene-acrylic resin is added to a recording layer containing polyvinyl alcohol. In another embodiment, a recording media is provided that contains a recording layer containing polyvinyl alcohol and polycarbonate urethane that is overcoated with a layer containing polyvinyl alcohol to improve gloss.

In accordance with one embodiment of the invention, the ink jet recording medium contains the layers identified in Table 1 in order from the substrate.

TABLE 1

| | |
|---|---|
| A1 | Gelatin (Top layer) |
| B1 | PVA and styrene acrylic copolymer latex |
| C1 | Gelatin |
| D1 | Gelatin (Bottom layer) |

Substrate

In another embodiment of the invention, the ink jet recording medium includes the layers shown in Table 2 in order from the substrate.

TABLE 2

| | |
|---|---|
| A2 | Gelatin (Top layer) |
| B2 | PVA and polycarbonate urethane |
| C2 | Gelatin |
| D2 | Gelatin (Bottom layer) |

Substrate

In accordance with still another embodiment of the invention, the ink jet recording medium includes the layers shown in Table 3 in order from the substrate. A recording layer containing polyvinyl alcohol and polycarbonate urethane may be overcoated with a layer containing polyvinyl alcohol and polystyrene acrylic latex in order to enhance the printed gloss and scratch resistance of the recording medium.

TABLE 3

| | |
|---|---|
| A3 | Gelatin (Top layer) |
| B3 | PVA and styrene acrylic copolymer latex |
| C3 | PVA and polycarbonate urethane |
| D3 | Gelatin |
| E3 | Gelatin (Bottom layer) |

Substrate

As the embodiments illustrated in Tables 1-3 illustrate, the ink jet recording media includes a plurality of layers that provide the image recording function. In these three embodiments, the layers contain gelatin and/or polyvinyl alcohol as the hydrophilic polymers. However, the invention is open to the use of other hydrophilic polymers. Representative examples of hydrophilic polymers include gelatin, gelatin derivatives, fully or partially hydrolyzed polyvinyl alcohol, homopolymers and copolymers such as polyvinyl pyrrolidone, hydroxyethyl cellulose, hydroxypropyl cellulose, hydroxypropylmethyl cellulose starches, polyethylene oxide, polyacrylamides, and the like. Also mixtures of these and other homopolymers and copolymers can be used.

Polyvinyl alcohol is available in different molecular weights and different degrees of hydrolysis. In accordance with one embodiment of the invention, a polyvinyl alcohol is selected that gives high absorptivity. In a particular embodiment of the invention, a blend of polyvinyl alcohol resins is used. In particular, in one embodiment, a combination of Elvanol 51-05 and Elvanol 40-16 has been used. The Elvanol products are commercially available from E. I. DuPont. Elvanol 51-05 is a partially hydrolyzed grade (e.g., 87.0-89.0% hydrolysis) having a low viscosity (e.g., 5.0-6.0 cps) (4% solids at 20° C.). Elvanol 40-16 is a medium viscosity (e.g., 13.0-17.0 cps) (4% solids at 20° C.) ultra-low hydrolysis (e.g., 79.3-83.7%) polyvinyl alcohol. These two resins may be used in a weight ratio of about 2/3 to 3/2 Elvanol 51-05: Elvanol 40-16.

Gelatin and modified gelatin layers are also particularly useful in the recording media. There is a variety of gelatins or modified gelatins, which can be used. For example, alkali-treated gelatin (cattle bone or hide gelatin) or acid-treated gelatin (pigskin gelatin), gelatin derivatives, like acetylated gelatin, phthalate gelatin and the like. These gelatins can be used singly or in combination for forming the solvent-absorbing layer used in the image-recording elements of the present invention. One type of gelatin that is useful is Imagel MA and is commercially available from Gelita AG. There are a variety of Imagels available for ink-jet paper, but others may be useful in other formulations.

In one embodiment, an amount of gelatin is added to a hydrophilic polymer to improve toughness. The amount of gelatin is limited to amounts that do not phase separate upon coating. For example, about 10 to 50 parts gelatin may be added per 100 parts polyvinyl alcohol. Stated differently, the gelatin to PVA weight ratio is about 10:90 to 30:70.

It has been found that the addition of a polycarbonate urethane to the polyvinyl alcohol layer improves the toughness of the layer or the resistance of the layer to softening upon application of the printing ink particularly in high density image areas. A particularly useful polyurethane carbonate is an aliphatic polycarbonate urethane available from Bayer AG under the name Bayhydrol 124 (Bayer AG) having a viscosity of about 50 to 400 mPas at 25° C. In one embodiment, the polyurethane carbonate is used in an amount that improves toughness without overly compromising gloss. In one embodiment, the polycarbonate urethane is added to the hydrophilic polymer in an amount of about 10 to 60 parts (dry weight) to 100 parts total polymer in the layer, e.g., PVA, gelatin, and polycarbonate urethane. Unless otherwise indicated, all percentages, ratios and coat weights set forth herein are by weight based on solids. A more preferred ratio range is from about 20 to 50 parts per 100 parts of the total polymer in the layer.

The polycarbonate urethane containing layer is typically applied in a coat weight of about 2 to 12 g/m² and more particularly about 3 to 10 g/m².

To compensate for the loss of gloss that can accompany the addition of the polycarbonate urethane, it has been found desirable in some embodiments of the invention, as illustrated in Example 2 below, to overcoat the polyvinyl alcohol-polycarbonate urethane layer with a layer of polyvinyl alcohol that does not contain the polycarbonate-urethane and improves gloss. In one embodiment, this gloss-improving layer may be applied in the minimum amount necessary to achieve the desired level of gloss. In another embodiment of the invention, this gloss-improving layer may be applied in an amount of about 0.2 to 2 g/m². In still another embodiment of the invention, it may be applied in an amount of about 0.25 to 1.50 g/m².

In still another embodiment of the invention, the ink jet recording material includes one or more layers containing a styrene-acrylic copolymer independently or in combination with one or more layers containing a polycarbonate urethane resin. The addition of this styrene-acrylic copolymer enhances the scratch resistance and printed gloss of the coating in certain embodiments.

One example of a styrene-acrylic copolymer that is useful in the present invention is DL280, which is available from Dow Reichhold Specialty Latex LLC. DL280 is a styrene-acrylic copolymer latex having a maximum viscosity of 500 cps and a Tg of 24° C. The weight ratio of the hydrophilic polymer to the styrene-acrylic copolymer can be adjusted to provide the desired combination of gloss, ink absorptivity and scratch resistance. In one embodiment, the styrene-acrylic copolymer is added to the layer in an amount of about 0 to 40 parts (dry weight) per 100 parts of the total polymer in the layer.

The hydrophilic polymers in the ink receiving layer(s) are preferably used in a total amount (total of all layers) of from about 1 to 30 g/m², and more particularly from about 2 to 20 g/m². In one embodiment, the ink jet-receiving sheet includes a plurality of ink receiving layers, each individual ink-receiving layer comprises typically an amount of gelatin or polyvinyl alcohol ranging from about 0.25 to 10 g/m².

If desired, the hydrophilic polymers and more particularly gelatin can be cross-linked in the image-recording elements of the present invention in order to impart mechanical strength to the layer. This can be done using any cross-linking agent known in the art (sometimes these cross-linking agents are also known as hardening agents). For gelatin, there are a number of known cross-linking agents. Examples include aldehyde compounds such as formaldehyde and glutaraldehyde, ketone compounds such as diacetyl and chloropentanedion, bis(2-chloroethylurea), 2-hydroxy-4,6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like. These hardeners can be used singly or in combination. The amount of hardener used, preferably ranges from 0.1 to 10 g, and more preferably from 0.15 to 7 g based on 100 g of gelatin contained in the ink-receiving layer. For more information on hardeners see U.S. Published Application 2005/0276935 to Fuji Photo Film Co. Ltd.

The recording layers may further contain one or more surfactants. Examples of surfactants include anionic surfactants, amphoteric surfactants, cationic surfactants, and non-ionic surfactants. Examples of anionic surfactants include alkylsulfocarboxylates, alpha olefin sulfonates, polyoxyethylene alkyl ether acetates, N-acylaminoacids and salts thereof, N-acylmethyltaurine salts, alkylsulphates, polyoxyalkylether sulphates, polyoxyalkylether phosphates, rosin soap, castor oil sulphate, lauryl alcohol sulphate, alkyl phenol phosphates, alkyl phosphates, alkyl allyl sulfonates, diethylsulfosuccinates, diethylhexylsulfosuccinates, dioctylsulfosuccinates and the like. Examples of the cationic surfactants include 2-vinylpyridine derivatives and poly-4-vinylpyridine derivatives. Examples of the amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctyl polyaminoethyl glycine, and imidazoline derivatives.

Useful examples of non-ionic surfactants include non-ionic fluorinated surfactants and non-ionic hydrocarbon surfactants. Useful examples of non-ionic hydrocarbon surfactants include ethers, such as polyoxyethylene nonyl phenyl ether, polyoxyethylene octyl phenyl ether, polyoxyethylene dodecyl phenyl ether, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate, polyoxyethylene stearate; glycol surfactants and the like. The above-mentioned surfactants are typically added to the coating in an amount ranging from about 0.1 to 1000 mg/m², preferably from about 0.5 to 100 mg/m².

The recording layer(s) optionally may further comprise one or more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate, etc.

One advantage of the recording layer of the present invention is that it does not require addition of a filler. However, in one embodiment, the recording layer(s) include one or more fillers. In another embodiment of the invention, the recording layer contains up to about 95% by weight filler. Both organic and inorganic particles can be used as fillers. Useful filler examples are represented by silica (colloidal silica), alumina or alumina hydrate (aluminazol, colloidal alumina, a cation aluminium oxide or its hydrate and pseudo-boehmite), a surface-processed cation colloidal silica, aluminium silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminium hydroxide, lithopone, zeolite, magnesium hydroxide and synthetic mica. Among these inorganic fillers, porous inorganic fillers are preferable such as porous synthetic silica, porous calcium carbonate and porous alumina. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), urea resins, urea-formalin resins. Such organic and inorganic fillers may by used alone or in combination.

The recording layer(s) may optionally further comprise one or more mordants. Mordants may be incorporated in the ink-receptive layer of the present invention. Such mordants are represented by cationic compounds, monomeric or polymeric, capable of complexing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha, alpha, alpha-trifluoro-m-tolyl)piperazine hydrochloride, 4-bromo-alpha, alpha, alpha-trifluoro-o-toluidine hydrochloride, difluorophenylhydrazine hydrochloride, 4-fluorobenzylamine hydrochloride, 4-fluoro-alpha, alpha-dimethylphenethylamine hydrochloride, 2-fluoroethylaminehydrochloride, 2-fluoro-1-methyl pyridinium-toluene sulfonate, 4-fluorophenethylamine hydrochloride, fluorophenylhydrazine hydrochloride, 1-(2-fluorophenyl)piperazine monohydrochloride, 1-fluoro pyridinium trifluoromethane sulfonate.

The recording layer may optionally further comprise one or more conventional additives, such as: white pigments such as titanium oxide, zinc oxide, talc, calcium carbonate and the like; blue pigments or dyes such as cobalt blue, ultramarine or phthalocyanine blue; magenta pigments or dyes such as cobalt violet, fast violet or manganese violet; biocides; pH controllers, preservatives; viscosity modifiers; dispersing agents; UV absorbing agents; brightening agents; anti-oxidants; and/or antistatic agents. These additives may be selected from known compounds and materials in accordance with the objects to be achieved. In one embodiment, the above-mentioned additives (matting agents, plasticizers, fillers/pigments, mordants, conventional additives) may be added in a range of 0 to 30% by weight, based on the solid content of the water-swellable ink receiving layer composition. In another embodiment the recording layer is microporous and contains over 50% additives.

The particle sizes of the non-water soluble additives should not be too large, since otherwise a negative influence on the resulting surface will be obtained. The particle size in one embodiment is preferably less than 10 μm, more preferably 7 μm or less. The particle size is preferably above 0.1 μm, more preferably about 1 μm or more.

The recording layer coating composition can be coated to a substrate by any method known in the art. The coating methods are for example, a curtain coating, an extrusion coating, an air-knife coating, a slide coating, a forward roll coating, reverse roll coating, dip coating and a rod bar coating.

If desired, the ink receiving layer of the present invention may be overcoated with an ink-permeable, anti-tack protective layer, such as, for example, a layer comprising gelatin or a cellulose derivative such as hydroxymethyl cellulose, hydroxyethyl cellulose, hydroxypropyl methyl cellulose and carboxymethyl cellulose. The topcoat layer, such as layers A1-A3 in the examples herein, serves to improve the optical density or to provide scratch resistance, color balance, gloss of the images printed on the element with water-based inks. The topcoat material may be preferably coated onto the swellable polymer layer from water or water-alcohol solutions at a dry thickness ranging from about 0.1 to 5.0 micrometers, preferably about 0.5 to 2.0 micrometers. The topcoat layer may be coated in a separate operation or may be coated concurrently with the water-swellable layer.

In practice, one or more additives may be employed in the topcoat. These additives include surface active agents which control the wetting or spreading action of the coating mixture, anti-static agents, suspending agents, particulates which control the frictional properties or act as spacers for the coated product, antioxidants, UV-stabilizers and the like. In a particular embodiment a topcoat containing a surfactant and an anti-blocking agent such as polystyrene, polymethyl methacrylate beads, and others may be used.

The support may suitably be selected from a paper, a photographic base paper, a synthetic paper or a plastic film in which the top and back coatings are balanced in order to minimize the curl behavior.

Examples of the plastic film support are polyolefins such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. Before coating the liquids onto the substrate, the substrate may be subjected to a corona treatment in order to improve the adhesion between the substrate and the coating. Also other techniques, like plasma treatment can be used to improve the adhesion.

Examples of embodiments of the invention are illustrated in more detail by the following non-limiting examples. Designations of parts in the examples indicate parts by mass. Any solutions that were made or dilutions of commercial samples were done with deionized water.

### EXAMPLE 1

The solutions Listed in Table 4, Example 1, were mixed at 40° C. with a paddle blade for twenty minutes. They were allowed to sit for at least twenty minutes under low agitation (approximately 10 rpm) to help reduce any foaming. They were then sonicated for three minutes prior to coating and any visible foam at the top of the solution was removed by suction. Any crosslinker was added just twenty minutes prior to start of coating and agitated for fifteen minutes.

TABLE 4
Example 1

| | % solids in | Parts (dry |
|---|---|---|
| | solution | weight) |
| Layer-1 (Bottom) | | |
| Gelatin | 18.00% | 33.28 |
| NaOH | 4.00% | 2.21 |
| Surfactant | 75.00% | 0.05 |
| Water | | 60.72 |
| Crosslinker | 8.00% | 3.73 |
| Layer-2 | | |
| Gelatin | 18.00% | 88.63 |
| NaOH | 4.00% | 4.57 |
| Water | | 6.80 |
| Layer-3 | | |
| Polyvinyl alcohol (Elvanol 51-05 from DuPont) | 18.00% | 24.36 |
| Polyvinyl alcohol (Elvanol 40-16 from DuPont) | 11.00% | 59.98 |
| Water | | 4.39 |
| NaOH | 4.00% | 1.27 |
| Styrene-acrylic copolymer latex DL-280 (Dow | 25.00% | 10.00 |
| Reichold Specialty Latex LLC) | | |
| Layer-4 (Top) | | |
| Imagel MA Gelatin from Gelita | 14.00% | 42.44 |
| Matting agent | 21.00% | 2.69 |
| Surfactant | 40.00% | 0.31 |
| Water | | 54.56 |

### COMPARATIVE EXAMPLE

The comparative example does not have DL-280 in the polyvinyl alcohol layer (Layer 3). The coating fluids for all other layers are the same as those in Example 1.

TABLE 5
Comparative example

| | % solids in | Parts (dry |
|---|---|---|
| Layer-3 | solution | weight) |
| Polyvinyl alcohol (Elvanol 51-05 from DuPont) | 18.00% | 28.51 |
| Polyvinyl alcohol (Elvanol 40-16 from DuPont) | 11.00% | 69.97 |
| NaOH | 4.00% | 1.53 |

### EXAMPLE 2

Example 2 replaces DL-280 in Layer 3 with Bayhydrol 124. It also has an extra layer (Layer 3b) between the topcoat and the Polyvinyl alcohol-Bayhydrol 124 layer to preserve gloss. Layer 5 is the same as Layer 4 of Example 1.

TABLE 6
Example 2

| | % solids in | Parts (dry |
|---|---|---|
| | solution | weight) |
| Layer-3 | | |
| Elvanol 51-05 from DuPont | 18.00% | 21.00 |
| Elvanol 40-16 from DuPont | 11.00% | 51.55 |
| Water | | 14.76 |
| NaOH | 4.00% | 1.13 |
| Bayhydrol 124 | 35.00% | 11.57 |
| Layer-3b | | |
| Elvanol 51-05 from DuPont | 18.00% | 13.35 |
| Elvanol 40-16 from DuPont | 11.00% | 32.76 |
| Water | | 53.21 |
| NaOH | 4.00% | 0.68 |
| Layer-4 (Top) | | |
| Imagel MA | 14.00% | 42.44 |
| Matting agent | 21.00% | 2.69 |
| Surfactant | 40.00% | 0.31 |
| Water | | 54.56 |

### EXAMPLE 3

In Example 3, DL-280 is included with the polyvinyl alcohol in layer 3b. All other coated layers (1,2,3,4) are the same as example 2.

TABLE 7
Example 3

| | % solids in | Parts (dry |
|---|---|---|
| Layer-3b | solution | weight) |
| Elvanol 51-05 from DuPont | 18.00% | 10.95% |
| Elvanol 40-16 from DuPont | 11.00% | 26.88% |
| Water | | 59.45% |
| NaOH | 4.00% | 0.56% |
| DL280 | 50.00% | 2.16% |

### Coating of Substrate to Make the Final Ink Jet Recording Medium

The coating solutions were sequentially coated on a paper substrate (having a thickness of 206 micrometers and laminated with polyethylene on both sides) with the wet coat weights listed in Table 8.

TABLE 8
Wet coat weights in cc/m2 of coated layers in above examples

| Layer | Comparative example | Example 1 | Example 2 | Example 3 |
|---|---|---|---|---|
| 1 | 9.728 | 9.728 | 9.728 | 9.728 |
| 2 | 43.450 | 43.450 | 43.450 | 43.450 |
| 3 | 45.40 | 43.13 | 43.13 | 43.13 |
| 3b | 10.70 | 10.70 | 16.47 | 16.47 |
| 4 | | | 10.70 | 10.70 |

During the coating, each coating liquid was maintained at 40° C., and a multilayer slide coating die was employed. Immediately after coating the resulting coat was cooled in a cooling zone maintained at 8.9° C. Thereafter, the coating was successively dried under a 30° C. air flow and 30% relative humidity, and was then subjected to moisture content control under an atmosphere of 25° C., and 60% RH.

While the coatings described were dried at fixed temperatures and humidities, it will be understood that on a commercial production basis, other drying methods may be preferred. Dryers having successive zones in which temperature and humidity can be closely controlled are in common use in the coating art and may be employed for these examples.

Recording onto Recording Medium and Evaluation

The resulting coated samples were treated under accelerated aging at 40° C. for 16 h to ensure complete reaction of the crosslinker. They were allowed to equilibrate at 25° C. and 50% relative humidity for at least 1 h prior to any recording.

For the evaluation of gloss and toughness, recording was conducted on these media by means of 2 ink jet printers, HP 7960 and Epson 960. The gloss, appearance of printer wheel marks, and waterfastness were measured at least 24 h after printing. Scratch resistance (adhesion) was tested approximately 2 h after printing.

Gloss was measured with Minolta Multi-Gloss 268 at 20 degrees. Improved fresh printed coating strength was evaluated by printer wheel mark. This mark is most noticeable in high density. The wheel can pick off the coating and ink leaving a white spot where the coating was removed. The heavier ink loading in the high-density areas softens the coating making it more susceptible to damage. Wheel mark was evaluated by visual observation in black and dark gray areas of the image.

Evaluation

| | |
|---|---|
| X | wheel mark readily visible |
| ◯ | Very faint mark, not easy to see |

Waterfastness was measured by applying 30 microliters of water to blocks of C, M, Y, K, R, G, and B. The water was allowed to sit for 30 seconds, and it was then tapped off at an angle and allowed to flow off the printed medium. The printed area was then observed for damage to the coating and ink loss.

Evaluation

| | |
|---|---|
| XX | Coating is disturbed as evidenced by wrinkles of the coating |
| X | Color is removed but coating remains intact |

Adhesion was tested by scratching a gray printed block with a blunt scraper. Any loss of coating was readily visible due to loss of color.

Evaluation

| | |
|---|---|
| XX | All color is removed |
| X | Most color is removed |
| ◯ | No color is removed |

TABLE 1

| | | | | |
|---|---|---|---|---|
| | Comparative | | | |
| Test | example | Example 1 | Example 2 | Example 3 |

Results of testing on HP 7960

| | | | | |
|---|---|---|---|---|
| Black gloss 20 deg | 57.7 | 72.6 | 38.9 | 47 |
| Grey gloss 20 deg | 58.4 | 61.8 | 48.2 | 54.4 |
| Black gloss 60 deg | 82.4 | 89.2 | 78.4 | 81.2 |
| Grey gloss 60 deg | 82.8 | 83.8 | 78 | 80.6 |
| Waterfastness | XX | XX | X | X |
| Adhesion | X | ◯ | ◯ | ◯ |
| Wheel mark | X | X | ◯ | ◯ |

Results of testing on Epson 960

| | | | | |
|---|---|---|---|---|
| Black gloss 20 deg | 25.5 | 48.8 | 35.3 | 48.1 |
| Grey gloss 20 deg | 33.3 | 40.1 | 38.7 | 41.2 |
| Black gloss 60 deg | 69.6 | 88.7 | 81.4 | 86 |
| Grey gloss 60 deg | 71.9 | 79.1 | 76.6 | 76.6 |
| Waterfastness | XX | XX | X | X |
| Adhesion | XX | XX | ◯ | ◯ |
| Wheel mark | ◯ | ◯ | ◯ | ◯ |

The results show that styrene-acrylic copolymer DL-280 is effective at improving printed gloss in both types of printers. The styrene-acrylic copolymer latex is also effective at improving toughness of printed areas for the HP printer. The polycarbonate urethane is effective at improving toughness as can be seen by waterfastness, wheel mark and adhesion testing.

Having described the invention in detail and by reference to specific embodiments thereof, those skilled in the art will recognize that numerous variations and modifications are possible without departing from the invention as defined by the following claims.

What is claimed is:

1. An ink jet recording medium comprising a support and at least one water-swellable layer carried on the support, the at least one water-swellable layer containing a blend of at least one hydrophilic polymer and a polycarbonate urethane resin.

2. The medium of claim 1 wherein the medium additionally includes at least one layer of a blend of at least one hydrophilic polymer and a styrene acrylic resin.

3. The medium of claim 2 wherein the hydrophilic polymer is selected from the group consisting of gelatin, gelatin derivatives, fully or partially hydrolyzed polyvinyl alcohol, homopolymers and copolymers such as polyvinyl pyrrolidone, hydroxyethyl cellulose, hydroxypropyl cellulose, hydroxypropylmethyl cellulose starches, polyethylene oxide, polyacrylamides, and mixtures thereof.

4. The medium of claim 3 wherein the hydrophilic polymer is a polyvinvl alcohol or a blend of polyvinyl alcohol and gelatin.

5. The medium of claim 4 wherein the medium additionally comprising an ink-permeable protective layer overlying the water-swellable layer.

6. The medium of claim 5 wherein the protective layer comprises a compound selected from the group consisting of hydroxypropyl methylcellulose, polyvinyl alcohol, gelatin, and mixtures thereof.

7. The medium of claim 6 wherein the support is paper, photographic base paper, synthetic paper, or a film.

8. The medium of claim 7 wherein the support is corona treated.

9. The medium of claim 2 wherein the styrene-acrylic polymer is added to the hydrophilic polymer in an amount about 10 to about 40 parts per 100 parts total polymer weight.

10. The medium of claim 1 wherein the polycarbonate urethane is added to the hydrophilic polymer in an amount about 20 to about 60 parts per 100 parts total polymer weight.

11. An ink jet recording medium comprising a support and at least one water-swellable layer carried on said support, the water-swellable layer containing a blend of at least one hydrophilic polymer and a styrene-acrylic resin.

12. The medium of claim 11 wherein the hydrophilic polymer is selected from the group consisting of gelatin, gelatin derivatives, fully or partially hydrolyzed polyvinyl alcohol, homopolymers and copolymers such as polyvinyl pyrrolidone, hydroxyethyl cellulose, hydroxypropyl cellulose, hydroxypropylmethyl cellulose starches, polyethylene oxide, polyacrylamides, or mixtures thereof.

13. The medium of claim 12 wherein the hydrophilic polymer is polyvinyl alcohol or a blend of polyvinyl alcohol and gelatin.

14. The medium of claim 13 wherein the medium additionally comprising an ink-permeable protective layer overlying the water-swellable layer.

15. The medium of claim 14 wherein the protective layer comprises a compound selected from the group consisting of hydroxypropyl methylcellulose, polyvinyl alcohol, gelatin, and mixtures thereof.

16. The medium of claim 15 wherein the support is paper, photographic base paper, synthetic paper, or a film.

17. The medium of claim 16 wherein the support is corona treated.

18. The medium of claim 11 wherein the styrene-acrylic polymer is added to the hydrophilic polymer in an amount about 10 to about 40 parts per 100 parts total polymer weight.

19. The medium of claim 18 wherein a polycarbonate urethane is added to the hydrophilic polymer in an amount about 20 to about 60 parts per 100 parts total polymer weight.

20. A method for forming an image comprising the steps of:
providing an ink jet recording medium comprising a support and at least one water-swellable layer carried on the support, the water-swellable layer containing a blend of at least one hydrophilic polymer and a polycarbonate-urethane resin, and
depositing an ink jet ink on the surface of said medium in the pattern of a desired image.
